(19) United States
(12) Patent Application Publication
(10) Pub. No.: US 2022/0188647 A1
(43) Pub. Date: Jun. 16, 2022

(54) MODEL LEARNING APPARATUS, DATA ANALYSIS APPARATUS, MODEL LEARNING METHOD AND PROGRAM

(71) Applicant: Nippon Telegraph and Telephone Corporation, Tokyo (JP)

(72) Inventors: Kengo TAJIRI, Musashino-shi, Tokyo (JP); Keishiro WATANABE, Musashino-shi, Tokyo (JP)

(21) Appl. No.: 17/603,207

(22) PCT Filed: Apr. 13, 2020
(86) PCT No.: PCT/JP2020/016274

§ 371 Date: Oct. 12, 2021

(30) Foreign Application Priority Data
Apr. 15, 2019 (JP) 2019-077274

(51) Int. Cl. G06N 3/08

(52) U.S. Cl. CPC G06N 3/088

(57) ABSTRACT

A model learning apparatus includes: a learning unit configured to train an unsupervised deep learning model using training data; a calculation unit configured to calculate a correlation between input dimensions in the deep learning model; and a division model learning unit configured to train an analysis model using the training data for each set of dimensions having a correlation.

### TECHNICAL FIELD

The present invention relates to an analysis using deep learning and in particular, relates to a continuous analysis of log data generated from large-scale network equipment or large quantities of data obtained from an IoT sensor group.

### BACKGROUND ART

Deep learning has been used for the purpose of improving accuracy for various tasks such as a classification problem (Non Patent Literature 1), future prediction (Non Patent Literature 1), or anomaly detection (Non Patent Literature 2), but in a technique of deep learning, there are two terms, that is, building of a deep learning model by training and evaluation of target data using a trained model, and there is a premise that dimensions of input data must be equal in these terms.

On the other hand, in log data generated from network equipment and data generated from an IoT sensor group, dimensionality of data input in deep learning may be changed due to replacement of equipment or a sensor or change of setting, and at this time, data whose dimensionality has been changed cannot be input to the trained model, thereby requiring retraining of the model. In addition, when a machine-learning technique is used, there is a problem in that when types of data to be analyzed (increasing in accordance with the number of pieces of network equipment or sensors in a case of the current problem setting) excessively increase, a computation complexity becomes too large and a data amount required for learning increases, whereby scaling cannot be achieved.

### CITATION LIST

### Non Patent Literature

Non Patent Literature 1: J. Schmidhuber, “Deep Learning in Neural Networks: An Overview”, Neural Networks, 61, 2015.
Non Patent Literature 2: R. Chalapathy and S. Chawla, “Deep Learning for Anomaly Detection: A Survey”, arXiv: 1901.03407, 2019.
Non Patent Literature 3: G. E. Hinton and R. R. Salakhutdinov, “Reducing the Dimensionality of Data with Neural Networks”, Science, 313 (5786), 2006.
Non Patent Literature 4: X. Guo, X. Liu, E. Zhu and J. Yin, “Deep Clustering with Convolutional Autoencoders”, ICONIP 2017.
Non Patent Literature 5: P. Vincent, H. Larochelle, Y. Bengio and P. A. Manzagol “Extracting and Composing Robust Features with Denoising Autoencoder”, ICML 2008
Non Patent Literature 6: D.P Kingma and M. Welling, “Auto-encoding Variational Bayes”, ICLR, 2014
Non Patent Literature 7: S. Bach, A. Binder, G. Montavon, F. Klauschen, K.R. Muller and W. Samek, “On Pixel-Wise Explanations for Non-Linear Classifier Decisions by Layer-Wise Relevance Propagation”, PloS one, 10(7), 2015.
Non Patent Literature 8: A. Shrikumar, P. Greenside and A. Kundaje, “Learning Important Features through Propagating Activation Differences”, ICML, 2017
Non Patent Literature 9: J. Macqueen, “Some Methods for Classification and Analysis of Multivariate Observations”, Proceedings of the fifth Berkeley Symposium on Mathematical Statistics and Probability, 1(14), 1967

### SUMMARY OF THE INVENTION

### Technical Problem

When retraining of a model is required due to change of dimensionality of data as described above, in a period of time to collect data necessary for training and a period of time to retrain the model using the data, tasks such as classification, prediction, or anomaly detection described above cannot be performed. In addition, when there are too many types of data to be analyzed, learning of a model for analysis sometimes cannot be performed in terms of a computation complexity and an amount of training data.

The present invention has been made in view of the foregoing points, and an object of the present invention is to provide a technology that enables continuous analysis even when in a technology of using a model to perform data analysis, retraining of the model is required due to change of dimensionality of data.

### Means for Solving the Problem

According to the disclosed technology, there is provided a model learning apparatus including: a learning unit configured to learn an unsupervised deep learning model using training data; a calculation unit configured to calculate a correlation between input dimensions in the deep learning model; and a division model learning unit configured to train an analysis model using the training data for each set of dimensions having a correlation.

### Effects of the Invention

According to the disclosed technology, in a technology of using a model to perform data analysis, there is provided a technology that enable continuous analysis even if retraining of a model is required due to a change of dimensionality of data.

### BRIEF DESCRIPTION OF DRAWINGS

FIG. 1 is a functional block diagram of an anomaly detection apparatus in handling small-scale data.

FIG. 2 is a functional block diagram of the anomaly detection apparatus in handling large-scale data.

FIG. 3 is a diagram illustrating an example of pre-processing of network log data.

FIG. 4 is a diagram illustrating an outline of contribution degree calculation.

FIG. 5 is a diagram illustrating an outline of division model relearning.

FIG. 6 is a diagram illustrating an example of analysis using anomaly detection as an example.

FIG. 7 is a diagram illustrating processing of correlation acquisition by a multi-stage deep learning model.

FIG. 8 is a diagram illustrating an example of a hardware configuration of an apparatus.

FIG. 9 is a flowchart illustrating processing of Examples 1 and 2.

FIG. 10 is a flowchart illustrating processing of Example 1.

FIG. 11 is a flowchart illustrating processing of Example 2.

FIG. 12 is a diagram illustrating an example of correlation division using an AE.

FIG. 13 is a diagram illustrating model division and anomaly detection accuracy.

### DESCRIPTION OF EMBODIMENTS

Hereinafter, an embodiment of the present invention (the present embodiment) will be described with reference to the drawings. The embodiment to be described below is merely an example, and embodiments to which the present invention is applied are not limited to the following embodiment. Furthermore, an example in which the present invention is applied to an anomaly detection apparatus is described below, but the present invention is not limited to the field of anomaly detection, and can be applied to a variety of fields.

Overview of Embodiment

In order to eliminate a time when a task cannot be executed and perform continuous analysis even if a change of dimensionality of data occurs, in the present embodiment, entire input data is not handled using one deep learning model, the deep learning model is divided based on a correlation between dimensions of the input data, and the input data is handled using a plurality of models. In this case, even if an input dimension is changed, only a model involving the changed dimension is retrained and analysis is continued for the other unrelated models to ensure the continuity of the analysis.

In addition, with regard to a problem relating to a building inability of an analysis model for the number of types of data to be analyzed, model division by a multi-stage correlation acquisition model reduces types of data handled by one model, whereby it is possible to reduce an amount of training data and a computation complexity.

Hereinafter, as a specific embodiment, Example 1 which is a model division technique for small-scale data and Example 2 which is a model division technique for large-scale data will be described.

### EXAMPLE 1

### Model Division Technique for Small-Scale Data Example 1 will be First Described

Functional Configuration Example

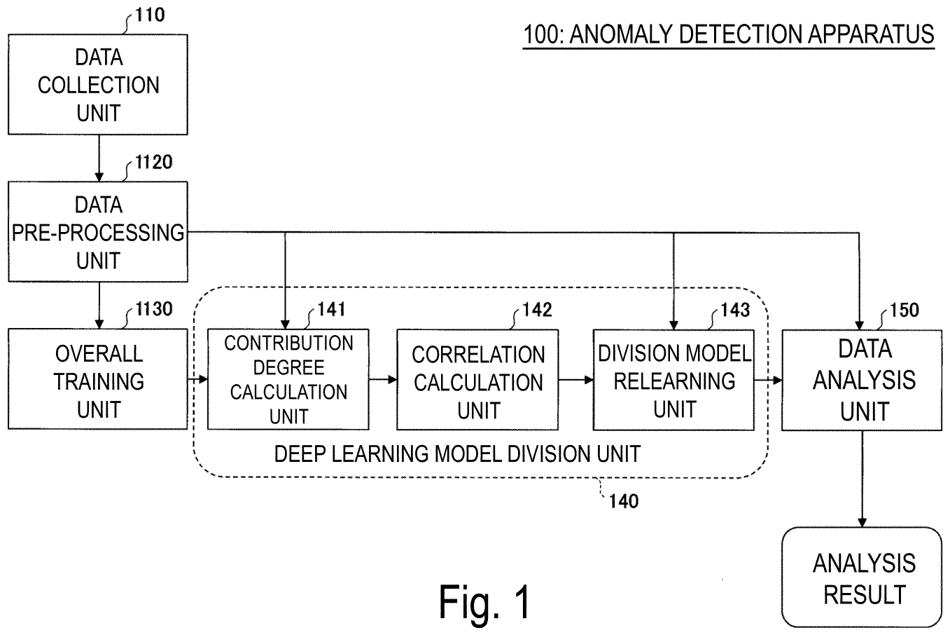

A functional block of an anomaly detection apparatus 100 in Example 1 is illustrated in FIG. 1.

As illustrated in FIG. 1, the anomaly detection apparatus 100 includes a data collection unit 110, a data pre-processing unit 120, an overall training unit 130, a deep learning model division unit 140, and a data analysis unit 150. The deep learning model division unit 140 includes a contribution degree calculation unit 141, a correlation calculation unit 142, and a division model relearning unit 143. Details of processing of each functional unit will be described later.

Note that the anomaly detection apparatus 100 includes a function of model learning, and thus may be referred to as a model learning apparatus. Alternatively, the anomaly detection apparatus 100 includes a function of data analysis, and thus may be referred to as a data analysis apparatus.

In addition, an apparatus excluding the data analysis unit 150 from the anomaly detection apparatus 100 may be referred to as a model learning apparatus. Alternatively, an apparatus excluding a functional unit for model learning (the overall training unit 130 and the deep learning model division unit 140) from the anomaly detection apparatus 100 may be referred to as a data analysis apparatus. The data analysis apparatus in this case stores a model trained in the division model relearning unit 143, and the model is used for data analysis.

Hardware Configuration Example

The anomaly detection apparatus 100 can be realized by causing a computer to execute a program describing details of processing as described in the present embodiment, for example. For example, analyzing data using a model can be achieved by inputting data to a computer and causing a computer to execute a program corresponding to the model.

That is, the anomaly detection apparatus 100 can be implemented by using hardware resources such as a CPU and a memory built in a computer to execute a program corresponding to processing executed by the anomaly detection apparatus 100. The above program can be recorded in a computer-readable recording medium (a portable memory or the like) and stored or distributed. In addition, the aforementioned program can also be provided through a network such as the Internet, an e-mail, and the like.

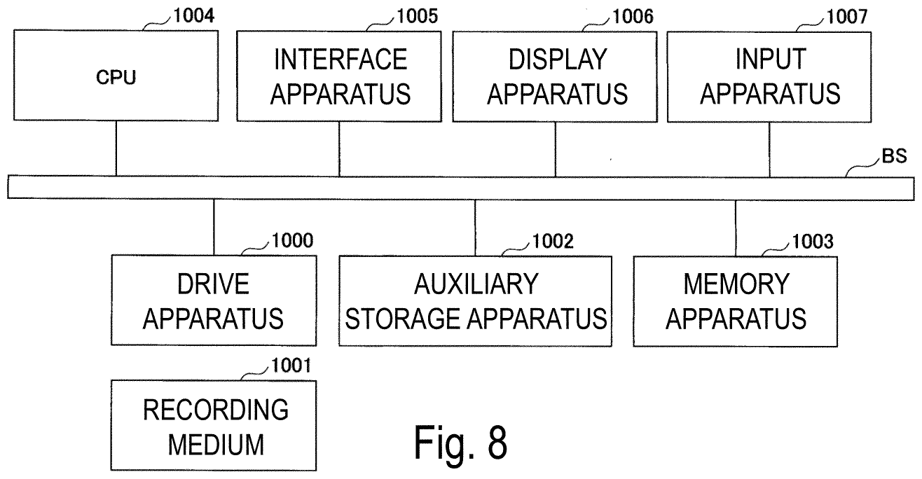

FIG. 8 is a diagram illustrating an example of a hardware configuration of the aforementioned computer in the present embodiment. The computer in FIG. 8 includes a drive apparatus 1000, an auxiliary storage apparatus 1002, a memory apparatus 1003, a CPU 1004, an interface apparatus 1005, a display apparatus 1006, an input apparatus 1007, and the like which are connected to each other through a bus B.

A program that implements processing in the computer is provided on, for example, a recording medium 1001 such as a CD-ROM or a memory card. When the recording medium 1001 storing the program is set in the drive apparatus 1000, the program is installed in the auxiliary storage apparatus 1002 from the recording medium 1001 through the drive apparatus 1000. However, the program does not necessarily have to be installed by the recording medium 1001, and may be downloaded from another computer through a network. The auxiliary storage apparatus 1002 stores the installed program and also stores necessary files, data, and the like.

The memory apparatus 1003 reads the program from the auxiliary storage apparatus 1002 and stores the program in a case where an instruction for starting the program is given. The CPU 1004 implements a function of the anomaly detection apparatus 100 in accordance with the program stored in the memory apparatus 1003. The interface apparatus 1005 is used as an interface for connection to the network. The display apparatus 1006 displays a graphical user interface (GUI) and the like according to the program. The input apparatus 1007 includes a keyboard, a mouse, buttons, a touch panel, and the like, and is used to input various operation instructions.

Note that the model learning apparatus and the data analysis apparatus described above can also be realized by causing a computer as illustrated in FIG. 8 to execute a program. In addition, an anomaly detection apparatus 200 (and a model learning apparatus and a data analysis apparatus) described in Example 2 can also be implemented by causing a computer as illustrated in FIG. 8 to execute a program.

Hereinafter, details of processing of each functional unit of the anomaly detection apparatus 100 will be described.

Data Collection Unit 110, Data Pre-Processing Unit 120

The data collection unit 110 collects network log data (numerical values, text) of an ICT system and sensor data of an IoT system, which are targets in the present Example. These data are sent to the data pre-processing unit 120 and shaped to be able to be used for deep learning.

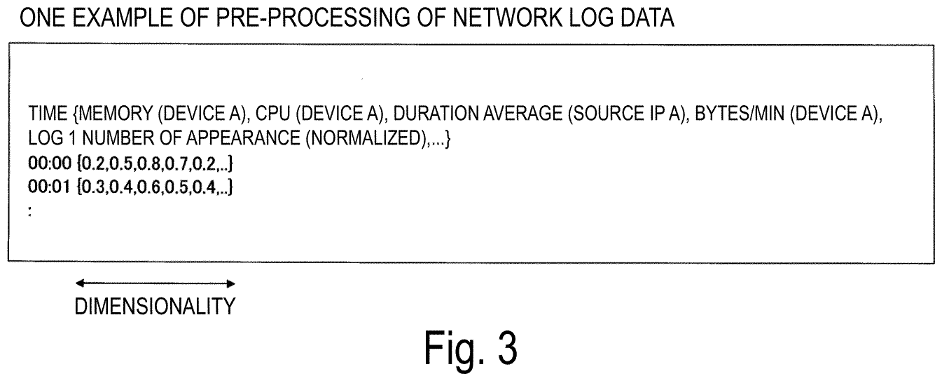

FIG. 3 illustrates an example of data obtained by pre-processing on network work log data.

As illustrated in FIG. 3, the shaped data takes the form of a matrix, a lateral direction or column is defined as dimensionality of the data, the number of columns is referred to as the number of dimensions, and each column is referred to as each dimension. For example, in the example of FIG. 3, the value of the dimension of “memory (device A)” obtained at time 00:00 is 0.2.

Overall Training Unit 130

The analytical technique as a target of model division is a deep learning model with high expressiveness, and thus correlation acquisition used for model division is also performed using a deep learning model. Thus, the overall training unit 130 uses the shaped data to build a deep learning model to examine a correlation between dimensions of data. As a deep learning model for acquiring a correlation, AutoEncoder (AE) (Non Patent Literature 3), Convolutional AutoEncoder (Non Patent Literature 4), Denoising AutoEncoder (Non Patent Literature 5), Variational AutoEncoder (VAE) (Non Patent Literature 6), and the like, each of which is an unsupervised data feature extraction model, can be used.

After the overall training unit 130 trains the deep learning model, the shaped data used for training and the trained deep learning model are input to the contribution degree calculation unit 141.

Contribution Degree Calculation Unit 141

In the present Example, the contribution degree calculation unit 141 and the correlation calculation unit 142 utilize an interpretation technique of a deep learning model by reverse propagation from an output side to an input side for an unsupervised deep learning model to calculate a correlation between dimensions of the input data. Details are as follows.

The AE (VAE) and derivatives thereof are models that perform training such that an output approaches an input while extracting features of input data within a deep learning model. Here, as a method for acquiring a correlation between dimensions of input data, among techniques proposed for the purpose of interpreting a deep learning model, a technique of calculating an importance degree of a dimension of data is used. As such a technique, there are known Layer-wise relevance propagation (LRP) (Non Patent Literature 7), DeepLIFT (Non Patent Literature 8), and the like. These techniques are techniques that indicate which dimension has contributed to an analysis result at the time of testing (analyzing) a classification problem. In the present Example, the technique is applied to the AE (VAE) and derivatives thereof that are models which perform learning to restore training data.

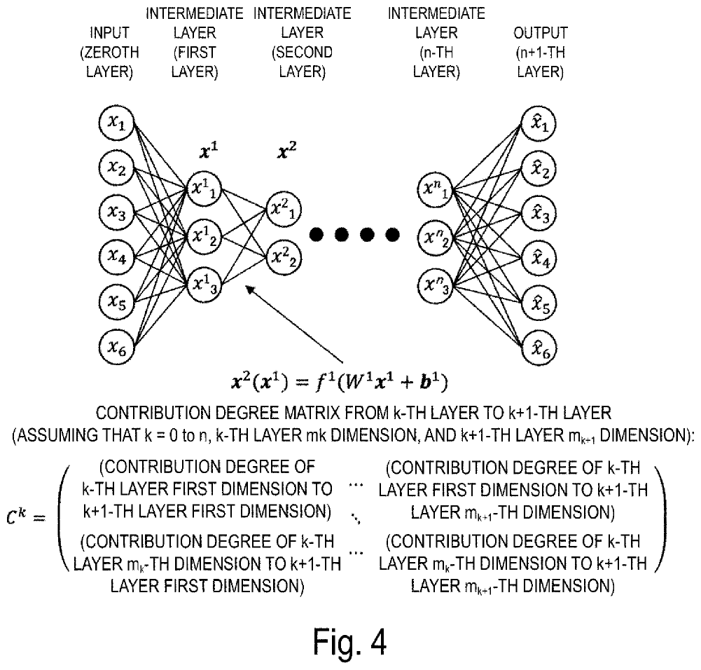

A method of calculating a contribution degree using the LRP or DeepLIFT performed by the contribution degree calculation unit 141 will be described with reference to FIG. 4.

As a contribution degree, (a) contribution degrees of respective inter-layers of adjacent layers can be obtained, and (b) a contribution degree of an input to a final output value by connecting the contribution degrees of (a). Among techniques proposed as interpretation techniques using the LRP and DeepLIFT, the simplest one will be described below as an example. Note that superscripts in the description of processing of the contribution degree calculation unit 141 each are not an index but a suffix.

(a) First, a contribution degree of each layer will be described. Here, an intermediate layer (first layer) and an intermediate layer (second layer) will be described as an example. Note that in the drawings and the images of mathematical formulas, a bold face represents a multidimensional vector. In a text in the specification, for a character representing a multidimensional vector, that effect will be described.

For the deep learning model in FIG. 4, (x¹, x²) (x is a multidimensional vector) is represented as follows, using a weight matrix W¹ linking a first layer and a second layer, a bias b¹ (b is a multidimensional vector), and a non-linear function

[Math. 1]

x²(x¹)=f¹(W¹x¹b¹) (1)

.W, b, f are generalized to be represent as W^{k}, a bias b^{k}, a non-linear function f^{k} for the k-th and k+1-th layers.

The contribution degree of a j-th dimension of x¹ to an i-th dimension of x² is represented as follows:

$$\begin{matrix}[ Math . 2 ] & \\ LRP \text{:} {C}_{i j}^{1} = ( \frac{\partial {x}_{i}^{2}}{\partial {x}_{j}^{1}} ) {x}_{j}^{1} , & ( 2 )\end{matrix}$$

when the contribution degree is represented as a ratio,

$$\begin{matrix}[ Math . 3 ] & \\ {C}_{i j}^{1} = ( \frac{\partial {x}_{i}^{2}}{\partial {x}_{j}^{1}} ) {x}_{j}^{1} \text{/} {\sum }_{j} ( \frac{\partial {x}_{i}^{2}}{\partial {x}_{j}^{1}} ) {x}_{j}^{1} & ( 3 ) \\ [ Math . 4 ] & \\ DeepLIFT \text{:} {C}_{i j}^{1} = \frac{{f}^{1} ( {\sum }_{j} {W}_{i j}^{1} {x}_{j}^{1} + {b}_{i}^{1} ) - {f}^{1} ( {b}_{i}^{1} )}{{\sum }_{j} {W}_{i j}^{1} {x}_{j}^{1}} {W}_{i j}^{1} {x}_{j}^{1} . & ( 4 )\end{matrix}$$

In the contribution degree calculation unit 141, the entire training data or some sampled training data is used as an input of a trained model, and the above contribution degree is calculated for each training data to take the average thereof. The contribution degree is calculated for not only the first layer and the second layer, but also all the layers from the zeroth layer and the first layer to the n-th layer and the n+1-th layer. In the lower part of FIG. 4, a contribution degree matrix C^{k} of the k-th layer to the k+1-th layer is illustrated, assuming that k is an integer of 0 to n, the k-th layer has mₖ dimensions, and the k+1-th layer has mₖ₊₁ dimensions.

(b) Based on the contribution degree Cᵢⱼ^{k} determined in (a), the contribution degree of each dimension of the input data to the final output can be determined for each of the LRP and the DeepLIFT. The results are as follows. In the following equation, i represents dimensionality of the output value, j represents dimensionality of the input data, and kₗ represents dimensionality of the 1-th layer.

$$\begin{matrix}[ Math . 5 ] & \\ LRP \text{:} {C}_{i j} = {\sum }_{{k}_{1} … {k}_{n}} ( \frac{\partial {\hat{x}}_{i}}{\partial {x}_{{k}_{n}}^{n}} ) ( \frac{\partial {x}_{{k}_{n}}^{n}}{\partial {x}_{{k}_{n - 1}}^{n - 1}} ) … ( \frac{\partial {x}_{{k}_{1}}^{1}}{\partial {x}_{j}} ) {x}_{j} & ( 5 )\end{matrix}$$

When the contribution degree is converted to a ratio:

$$\begin{matrix} [ Math . 6 ] & \\ {C}_{i j}^{1} = {\sum }_{{k}_{1} … {k}_{n}} ( \frac{\partial {\hat{x}}_{i}}{\partial {x}_{{k}_{n}}^{n}} ) ( \frac{\partial {x}_{{k}_{n}}^{n}}{\partial {x}_{{k}_{n - 1}}^{n - 1}} ) … ( \frac{\partial {x}_{{k}_{1}}^{1}}{\partial {x}_{j}} ) {x}_{j} \text{/} {\sum }_{j {k}_{1} … {k}_{n}} ( \frac{\partial {\hat{x}}_{i}}{\partial {x}_{{k}_{n}}^{n}} ) ( \frac{\partial {x}_{{k}_{n}}^{n}}{\partial {x}_{{k}_{n - 1}}^{n - 1}} ) … ( \frac{\partial {x}_{{k}_{1}}^{1}}{\partial {x}_{j}} ) {x}_{j} & ( 6 ) \\ [ Math . 7 ] & \\ DeepLIFT \text{:} {C}_{i j} = {\sum }_{{k}_{1} … {k}_{n}} \frac{{f}^{n} ( {\sum }_{{k}_{n}} {W}_{i {k}_{n}}^{n} {x}_{{k}_{n}}^{n} + {b}_{i}^{n} ) - {f}^{n} ( {b}_{i}^{n} )}{{\sum }_{{k}_{n}} {W}_{i {k}_{n}}^{n} {x}_{{k}_{n}}^{n}} {W}_{i {k}_{n}}^{n} \frac{{f}^{n - 1} ( {\sum }_{{k}_{n - 1}} {W}_{ {k}_{n} {k}_{n - 1}}^{n - 1} {x}_{{k}_{n - 1}}^{n - 1} + {b}_{{k}_{n}}^{n - 1} ) - {f}^{n - 1} ( {b}_{{k}_{n}}^{n - 1} )}{{\sum }_{{k}_{n - 1}} {W}_{i {k}_{n - 1}}^{n - 1} {x}_{{k}_{n - 1}}^{n - 1}} {W}_{{k}_{n} {k}_{n - 1}}^{n - 1} … \frac{{f}^{0} ( {\sum }_{j} {W}_{{k}_{1} j}^{0} {x}_{j} + {b}_{{k}_{1}}^{1} ) - {f}^{0} ( {b}_{{k}_{1}}^{1} )}{{\sum }_{j} {W}_{{k}_{1} j}^{0} {x}_{j}} {W}_{{k}_{1} j}^{0} {x}_{j} & ( 7 )\end{matrix}$$

For the contribution degree in this case as well, similarly to (a), the entire training data or some sampled training data is used as an input of a trained model, and the above contribution degree is calculated for each training data to take the average thereof.

Correlation Calculation Unit 142

The correlation calculation unit 142 and the division model relearning unit 143 cluster dimensions of the input data based on correlations between dimensions of the input data to build a deep learning model for analysis for each cluster. Details are as follows.

The correlation calculation unit 142 acquires a correlation of the input dimensions using the contribution degree calculated by the contribution degree calculation unit 141. As a correlation acquisition method, there are roughly two techniques: (1) a method of setting a threshold for a contribution degree, and (2) a technique of setting the number of clusters. Each of them will be described in detail below.

(1) For a method of setting a threshold for a contribution degree, by changing a stage in which the threshold is used, there are two techniques (I) and (II) described below.

(I) The following binary matrix B^{k} (k=0 to n) is created by using the contribution degree matrix C^{k} (k=0 to n) calculated in the aforementioned method (a) by the contribution degree calculation unit 141.

$$\begin{matrix}[ Math . 8 ] & \\ {B}_{i j}^{k} = \{ \begin{matrix}0 ( {C}_{i j}^{k} < {ɛ}_{k} ) \\ 1 ( {C}_{i j}^{k} ≧ {ɛ}_{k} )\end{matrix} & ( 8 )\end{matrix}$$

Further, Equation (5) is used to calculate

[Math. 9]

B=B⁰B¹ Bⁿ (9),

whereby the binary matrix B representing whether dimensions of an input and an output are connected can be obtained. The dimensions of the input and the output are equal for the AE, the VAE, or the like, and thus the matrix is a square matrix. The row direction of the square matrix is an input dimension and the column direction thereof is an output dimension.

The correlation calculation unit 142 decomposes the square matrix into column vectors B1 of the number of input and output dimensions and performs the following internal product calculation for all dimension pairs to calculate a correlation.

If Bᵢ·Bⱼ equals to 0, then there is no correlation between a dimension i and a dimension J.

If Bᵢ·Bⱼ is larger than 0, then there is a correlation between a dimension i and a dimension j.

The correlation calculation unit 142 performs the above calculation for all dimension pairs and clusters dimensions for each group having a correlation.

(II) The correlation calculation unit 142 decomposes the contribution degree matrix C calculated in the method (b) described above by the contribution degree calculation unit 141 into column vectors calculates a pairwise distance for each column vector, and sets a threshold value for the pairwise distance, thereby calculating a correlation. Here, as a definition of distance,

a Minkowski's distance including L_1 and L_2 distances:

$$\begin{matrix}[ Math . 10 ] & \\ {L}_{p} = {( {\sum }_{k} {\vert {x}_{k} - {y}_{k} \vert}^{p} )}^{\frac{1}{p}} , & ( 10 )\end{matrix}$$

a cosine similarity:

$$\begin{matrix}[ Math . 11 ] & \\ cos ( x , y ) = \frac{{\sum }_{k} {x}_{k} {y}_{k}}{\sqrt{{\sum }_{k} {x}_{k}^{2}} \sqrt{{\sum }_{k} {y}_{k}^{2}}} , & ( 11 )\end{matrix}$$

and the like can be used. Note that the superscripts of the above equations each are an index.

If there are dimensions that have no correlation with all dimensions including themselves, either of two handling ways, that is, i) gathering together the dimensions and considering them as a group of one correlation, or ii) not using the dimensions for subsequent analysis, can be used.

(2) As a technique of performing clustering after determining the number of clusters, a kMeans method (Non Patent Literature 9) can be mainly used. As an input of clustering, C1 is used, similarly to (II) of (1). In this case as well, when isolated dimensions occur, either of two pattern, that is, i) considering them as one correlation group and ii) considering each of them as an independent correlation group, can be used.

Division Model Relearning Unit 143

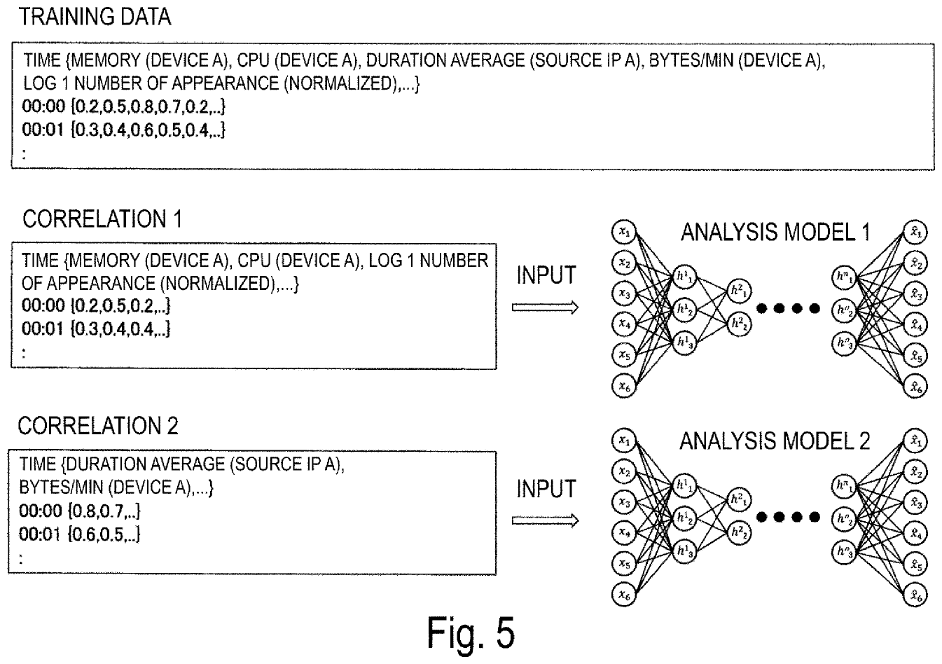

In the division model relearning unit 143, an analysis model is trained for each dimension having a correlation by using the correlation obtained in the correlation calculation unit 142 and the training data used for training the correlation acquisition model in the overall training unit 130 to perform training. A specific example of the processing is illustrated in FIG. 5.

It is assumed that the correlation calculation unit 142 has divided the training data illustrated in FIG. 5 into two correlations: a correlation 1 {memory (device A), CPU (device A), number of appearance of log 1 (normalized), . . . }, and a correlation 2 {duration average (source IP A), Bytes/min (device A), . . . }.

The division model relearning unit 143 inputs data corresponding to the correlation 1 to an analysis model 1 to train the analysis model 1, and inputs data corresponding to the correlation 2 to an analysis model 2 to train the analysis model 2. In this way, data is input to a model for each correlation to redo training. The trained analysis models each are stored in the data analysis unit 150.

Data Analysis Unit 150

Finally, the data analysis unit 150 inputs data used in a test (analysis) separately for each of dimensions corresponding to the plurality of models created in the division model relearning unit 143, and outputs analysis results.

When, in outputting the analysis results, outputs of all the models are eventually required to be output collectively as one result, as a method therefor, processing, for example, a) taking an average of output results obtained from all models, or b) binarizing output results of respective models and taking an average thereof, is performed.

For example, in the case of a classification problem, when dimensions of data to be analyzed are divided, and the dimension-divided data is input to each model obtained in the division model relearning unit 143, each model outputs a probability corresponding to each label. When probabilities are output as a single analysis result, for example, a) averaging and standardizing the probabilities in all models, orb) ranking the probabilities of respective models and adopting a voting system is thinkable.

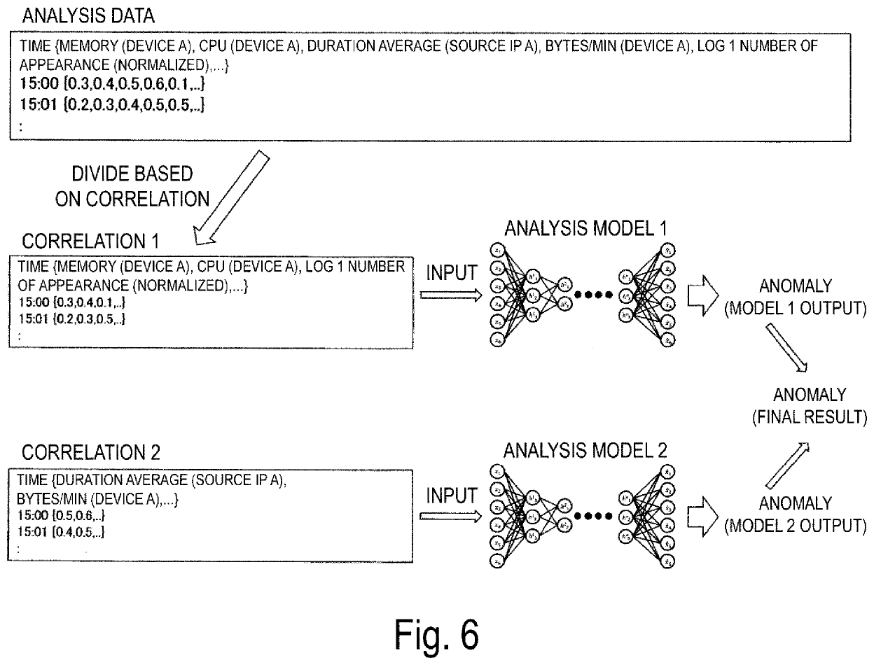

A specific example of analysis by a correlation-divided model group with anomaly detection as an example is illustrated in FIG. 6. In the example illustrated in FIG. 6, analysis data is divided into data of dimensions corresponding to the correlation 1 and data of dimensions corresponding to the correlation 2. The data of dimensions corresponding to the correlation 1 is input into the analysis model 1 in the data analysis unit 150, and the data of dimensions corresponding to the correlation 2 is input to the analysis model 2 in the data analysis unit 150. In the example of FIG. 6, “anomaly” is output from any of the model 1 and the model 2, and the data analysis unit 150 puts them together to output a final result (“anomaly”).

The inability to continue due to structural changes of data described in the problem to be solved by the invention will be described. For example, if the number of dimensions decreases, the anomaly detection apparatus 100 continues analysis using only the other models excluding models correlating with a disappearing dimension. If the number of dimensions increases, the anomaly detection apparatus 100 first excludes the increased dimension to perform analysis, considers, as a model influenced by a change of dimensionality, a model that has changed so that the behavior is greatly different from the past, and uses the remaining models excluding the model to perform analysis in the subsequent analysis.

### EXAMPLE 2

### Model Division Technique for Large-Scale Data

Next, Example 2 will be described. In Example 2, a correlation of overall dimensions of input data is acquired by a staged use of a deep learning model such that dimensions of the input data are arbitrarily divided, correlations between dimensions present in the divided dimensions are obtained in the manner described in Example 1, an unsupervised deep learning model for feature extraction is built for each set of dimensions divided in accordance with correlations in the manner described in Example 1, the extracted feature is used to obtain an overall correlation. This will be described in more detail below.

In Example 1, the overall training unit 130 is introduced to train a deep learning model for acquiring a correlation. However, when dimensions of data to be handled increase, training by the overall training unit 130 may become impossible.

In a case where it is intended to calculate a contribution degree by the method of Example 1, when data processing cannot be performed using one correlation learning model due to the magnitude of the number of dimensions to generate an error, correlation division for large-scale data is performed by the technique described below.

Functional Configuration Example

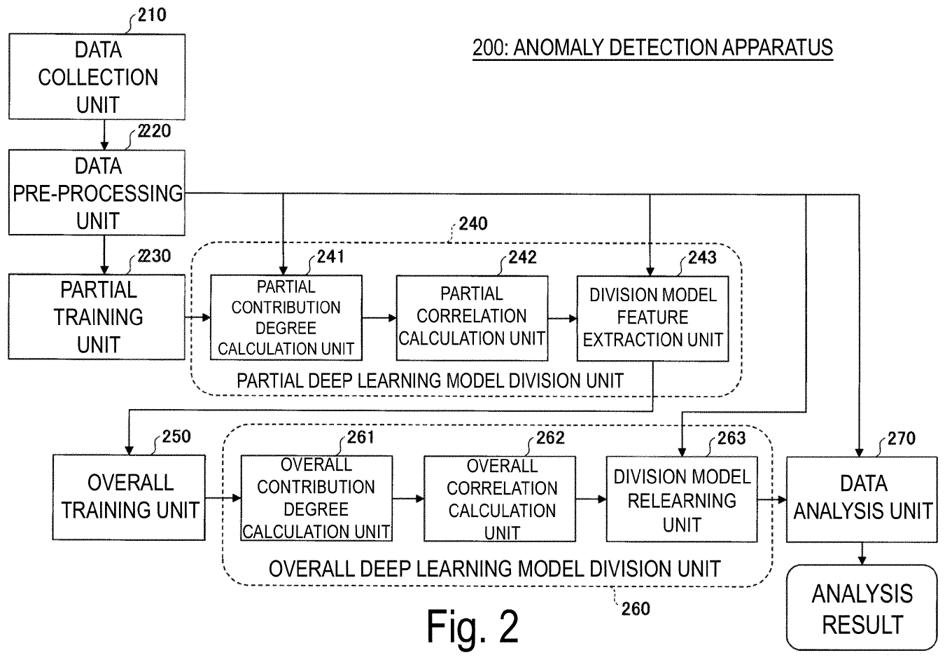

A functional block of the anomaly detection apparatus 200 in Example 2 is illustrated in FIG. 2.

As illustrated in FIG. 2, the anomaly detection apparatus 200 includes a data collection unit 210, a data pre-processing unit 220, a partial training unit 230, a partial deep learning model division unit 240, an overall training unit 250, an overall deep learning model division unit 260, and a data analysis unit 270. The partial deep learning model division unit 240 includes a partial contribution degree calculation unit 241, a partial correlation calculation unit 242, and a division model feature extraction unit 243. The overall deep learning model division unit 260 includes an overall contribution degree calculation unit 261, an overall correlation calculation unit 262, and a division model relearning unit 263.

Note that the anomaly detection apparatus 200 includes a function of model learning, and thus may be referred to as a model learning apparatus. Alternatively, the anomaly detection apparatus 200 includes a function of data analysis, and thus may be referred to as a data analysis apparatus.

In addition, an apparatus excluding the data analysis unit 270 from the anomaly detection apparatus 200 may be referred to as a model learning apparatus. Alternatively, an apparatus excluding a functional unit for model learning (the partial training unit 230, the partial deep learning model division unit 240, the overall training unit 250, and the overall deep learning model division unit 260) from the anomaly detection apparatus 200 may be referred to as a data analysis apparatus. A model trained in the division model relearning unit 263 is input to the data analysis apparatus in this case, and the model is used for data analysis.

In addition, an anomaly detection apparatus (or a model learning apparatus, a data analysis apparatus) including both the function of the anomaly detection apparatus 100 of Example 1 (or the model learning apparatus and the data analysis apparatus of Example 1) and the function of the anomaly detection apparatus 200 of Example 2 (or the model learning apparatus and the data analysis apparatus of Example 2) may be used. In such an anomaly detection apparatus (or a model learning apparatus), for example, when the magnitude of the input data is too large to generate an error in training in the overall training unit 130, the processing can be shifted to processing in the partial training unit 230.

The processing contents of functional units of Example 2 will be described below.

Data collection unit 210, data pre-processing unit 220, partial training unit 250 The processing contents by the data collection unit 210 and the data pre-processing unit 220 are basically the same as the processing contents by the data collection unit 110 and the data pre-processing unit 120 of Example 1.

In Example 2, the data pre-processing unit 220 arbitrarily divides input dimensions when the input dimensions become large in pre-processing. Note that this division may be performed by the partial training unit 230. As a way of division, division based on an actual position of network equipment or a sensor, division based on a type of data, or the like can be performed.

The partial training unit 230 creates a deep learning model for using arbitrarily divided training data to acquire a correlation therein. Here, as a correlation acquisition model used in the partial training unit 230, the AE (VAE) and an unsupervised deep learning model that is a derivative of the AE (VAE) can be used, similarly to Example 1. The training data is divided in Example 2, and thus the partial training unit 230 trains a model of each of the divided training data. In this way, a plurality of models is trained.

Partial contribution degree calculation unit 241, partial correlation calculation unit 242 The processing contents of the partial contribution degree calculation unit 141 and the partial correlation calculation unit 242 are the same as the processing contents of the contribution degree calculation unit 241 and the correlation calculation unit 142 described in Example 1. However, in Example 2, a correlation among arbitrarily divided dimensions is examined for each model obtained by the partial training unit 230.

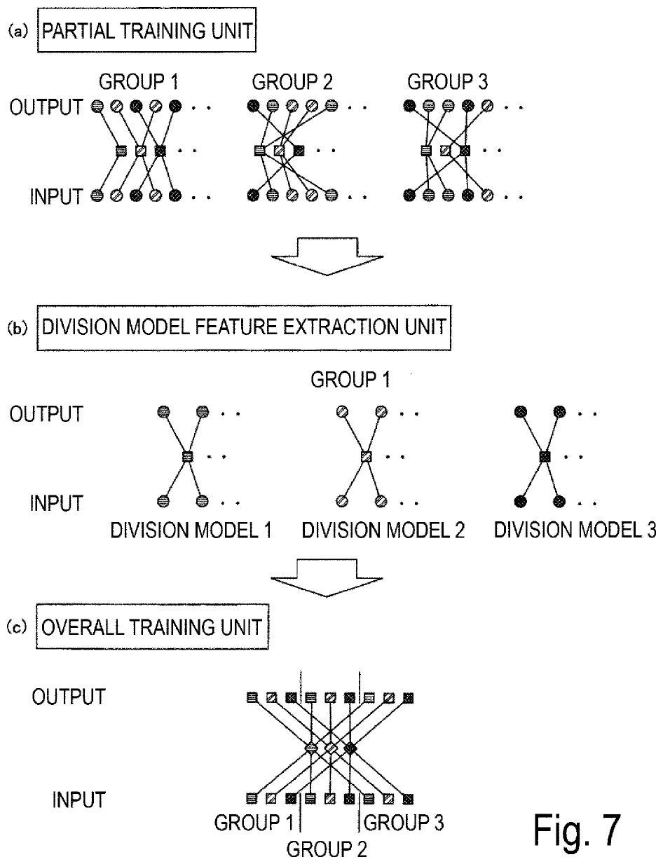

A specific example is illustrated in FIG. 7(a). In the example illustrated in FIG. 7(a), it is assumed that pre-processing data has been arbitrarily decomposed into three groups, and a correlation is acquired for each group by the partial correlation calculation unit 242. In FIG. 7(a), it is illustrated that nodes of an identical shading in a group have a correlation.

Division Model Feature Extraction Unit 243

The processing content of the division model feature extraction unit 243 is basically the same as that of the division model relearning unit 143. In the division model feature extraction unit 243, the model is further divided based on the correlation among each arbitrarily divided group to train a model such as the AE or the VAE that extracts features, using training data.

A specific example is illustrated in FIG. 7(b). The division model feature extraction unit 243 performs model division based on correlations in each group, and trains a deep learning model to extract a feature in each correlation. FIG. 7(b) illustrates that group 1 is divided into division models 1 to 3 and the like, and the division model feature extraction unit 243 trains the deep learning model for each of the division models. In the case of three groups, the same training is performed in the groups 2 and 3.

Overall Training Unit 250

In the overall training unit 250, what is obtained by arranging, for all models of all groups, data output from an intermediate layer with reduced dimensions obtained when training data is input to a model trained by the division model feature extraction unit 243 is used as an input for a correlation acquisition model. Similarly to the overall training unit 130 of Example 1, the AE (VAE) and derivatives thereof can be also used as a correlation acquisition model used in the overall training unit 250.

Overall contribution degree calculation unit 261, overall correlation calculation unit 262, division model relearning unit 263, and data analysis unit 270 For the deep learning model trained in the overall training unit 250 as well, the overall contribution degree calculation unit 261 calculates a contribution degree and the overall correlation calculation unit 262 calculates a correlation regarding input data of the intermediate layer. The processing contents of the overall contribution degree calculation unit 261 and the overall correlation calculation unit 262 are the same as those of the contribution degree calculation unit 241 and the correlation calculation unit 242 in Example 1.

In the overall deep learning model division unit 260, it has been grasped which correlation the intermediate layers of the model of the division model feature extraction unit 243 used for the input belongs to, and thus it is possible to grasp the correlation of the entire input dimensions from these pieces of information. The dimensions of the input data are redivided on the basis of this correlation, and analysis model relearning and analysis similar to those of Example 1 are performed in the division model relearning unit 263 and the data analysis unit 270.

For example, it is assumed that when training data is arbitrarily divided into three groups, a division model 11, a division model 12, and a division model 13 for a group 1, a division model 21 and a division model 22 for a group 2, and a division model 31, a division model 32, a division model 33, and a division model 34 for a group 3 are obtained by the division model feature extraction unit 243.

At this time, in the overall training unit 250, output data from an intermediate layer of each of the division model 11, the division model 12, the division model 13, the division model 21, the division model 22, the division model 31, the division model 32, the division model 33, and the division model 34 is used as an input for a correlation acquisition model to be trained. Assuming that the output of each intermediate layer has two dimensions. The input dimensions (and output dimensions) of the correlation acquisition model are 18 dimensions.

It is assumed that the overall correlation calculation unit 262 has found that there is a correlation between the first dimension and the tenth dimension in the 18 dimensions, for example. Then, it is assumed that the first dimension belongs to a correlation corresponding to the division model 11 and the tenth dimension belongs to a correlation corresponding to the division model 32. In addition, it is assumed that the correlation corresponding to the division model 11 is the second dimension, the fifth dimension, and the sixth dimension of the original training data, and the correlation corresponding to the division model 32 is the fourth dimension, the seventh dimension, and the eighth dimension of the original training data. At this time, for the correlations, the division model relearning unit 262 is to train analysis models of the second dimension, the fourth dimension, the fifth dimension, the sixth dimension, the seventh dimension, and the eighth dimension of the original training data.

A specific example is illustrated in FIG. 7(c). The intermediate layers of all the models of all the groups are arranged side-by-side to eventually calculate an inter-dimension correlation in the overall training unit 250, the overall contribution degree calculation unit 261, and the overall correlation calculation unit 262. In the example of FIG. 7(c), the intermediate layers of the identical shading of the groups 1, 2, and 3 have a correlation (the output dimensions are joined), and thus, dimensions of the identical shading have a correlation across the groups 1, 2, and 3.

Processing Flow

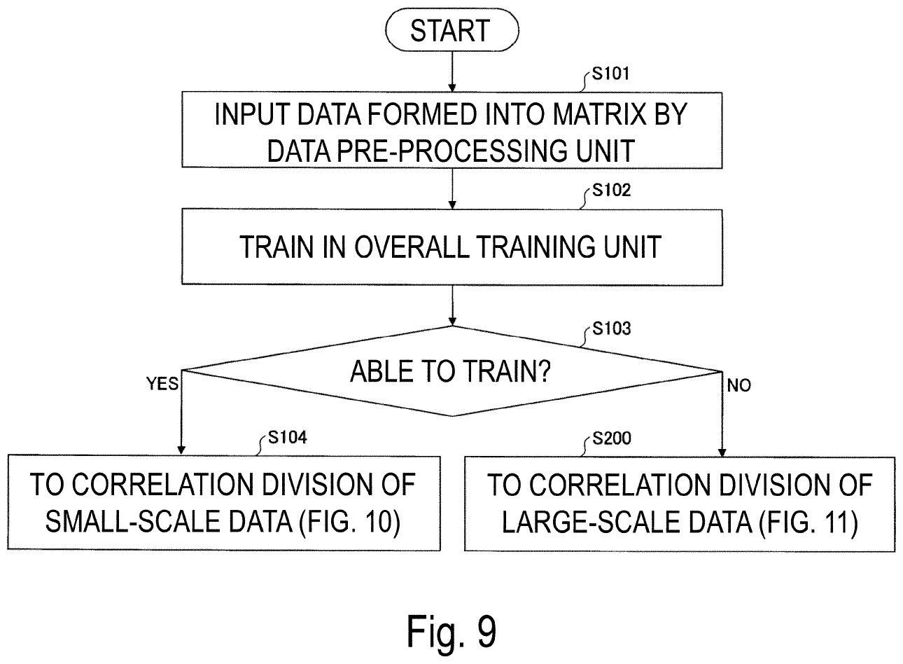

The overall processing flow of Example 1 and Example 2 will be described with reference to the flowcharts of FIGS. 9 to 11. In the example described below, the anomaly detection apparatus 100 of Example 1 is first used, and the anomaly detection apparatus 100 of Example 1 is used continuously or the anomaly detection apparatus 200 of Example 2 is used, in accordance with the magnitude of the data. Note that the processing content of each of the functional units has already been described, and thus will be briefly described.

At S101, data formed into a matrix by the data pre-processing unit 120 is input to the overall training unit 130.

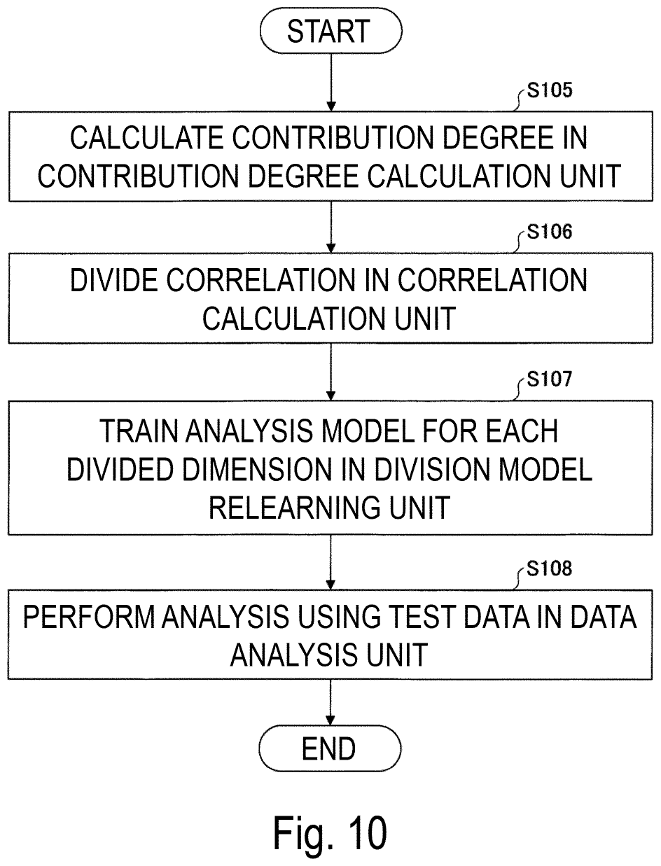

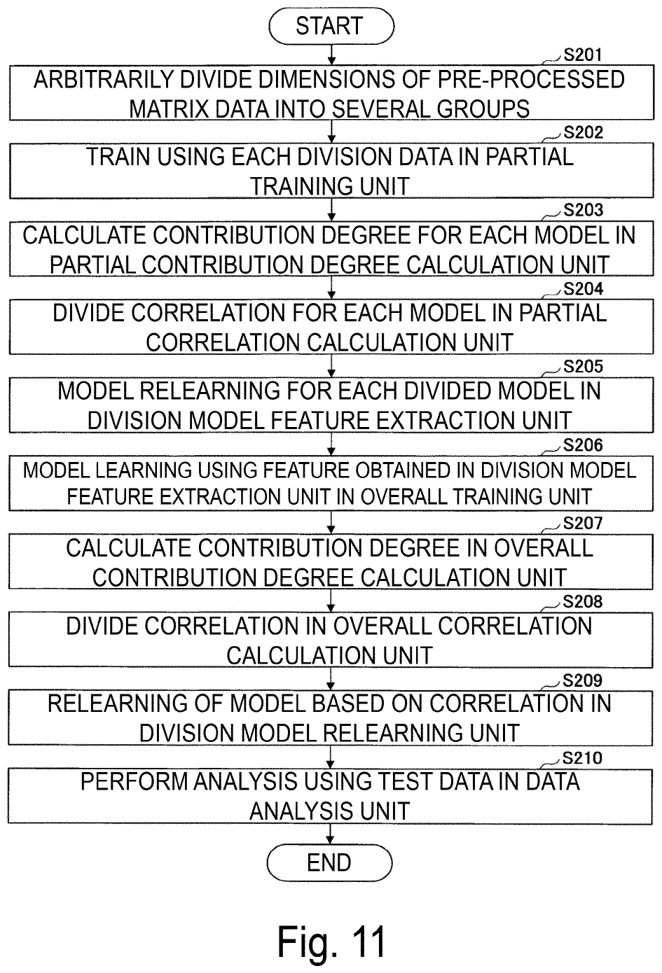

The overall training unit 130 performs training at S102, but when the magnitude of the data is large, training cannot be performed (No at S103) and thus the processing proceeds to S200 (correlation division of large-scale data (FIG. 11)). In the other case (Yes at S103), the processing proceeds to S104 (correlation division of small-scale data (FIG. 10)). First, the processing that has proceeded to S104 (correlation division of small-scale data (FIG. 10)) will be described.

At S105 in FIG. 10, the contribution degree calculation unit 141 calculates a contribution degree. At S106, the correlation calculation unit 142 calculates a correlation and divides dimensions of the training data.

At S107, the division model relearning unit 143 trains an analysis model for each divided dimension. At S108, the data analysis unit 150 performs an analysis on test data using the analysis model trained by the division model relearning unit 143.

Next, the processing that has proceeds to S200 (a correlation division of large-scale data (FIG. 11)) will be described.

At S201, the data pre-processing unit 220 arbitrarily divides dimensions of the pre-processed matrix data into several groups. At S202, the partial training unit 230 uses each divided data to train a model for each divided group.

At S203, the partial contribution degree calculation unit 241 calculates a contribution degree for each model. At S204, the partial correlation calculation unit 242 calculates a correlation for each model, and performs division of dimensions for each model. At S205, the division model feature extraction unit 243 performs model relearning for each divided model.

At S206, the overall training unit 250 performs model learning using a feature obtained in the division model feature extraction unit 243. At S207, the overall contribution degree calculation unit 261 calculates a contribution degree. At S208, the overall correlation calculation unit 262 calculates a correlation and performs division of dimensions based on the correlation.

At S209, the division model relearning unit 263 performs relearning of the model divided based on the correlation. At S210, the data analysis unit 270 performs analysis on the test data using the analysis model trained by the division model relearning unit 263.

Effects of Technology According to Embodiment

The technology according to the present embodiment described using Examples 1 and 2 can address the problem of inability to continue the analysis task when a structural change of data occurs without lowering the analytical accuracy by dividing a model based on data correlation characteristics.

In the following, a task of anomaly detection will be given as an example, and it will be presented that a model can be divided without lowering the accuracy.

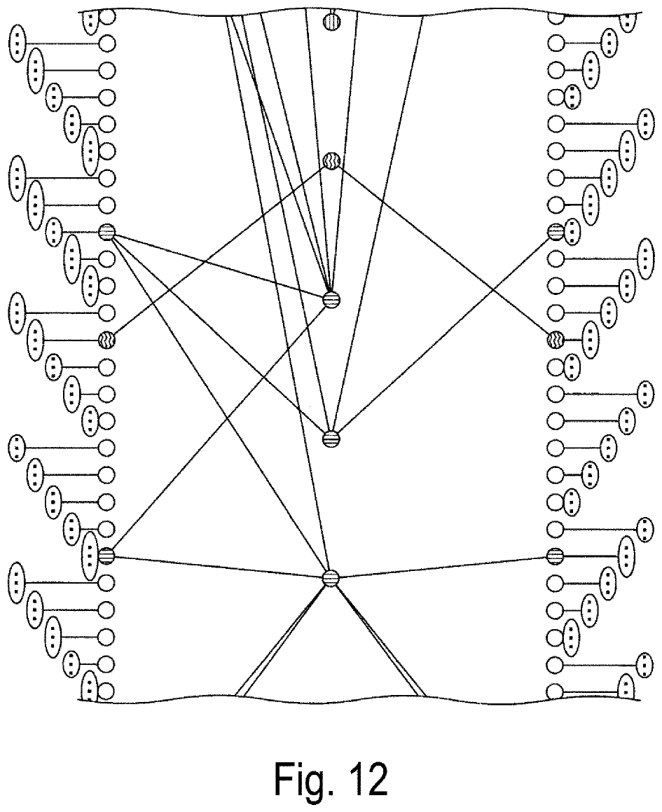

A result will be shown that anomaly detection using the AE for benchmark data of a network intrusion detection system called KSL_KDD is divided based on a correlation. FIG. 12 illustrates a result (in part) of a correlation division using the AE, where circles represent dimensions of an input, an intermediate layer, and an output from the bottom side, and it is determined by the present technique that circles of dimensions of the input having identical shading have a correlation.

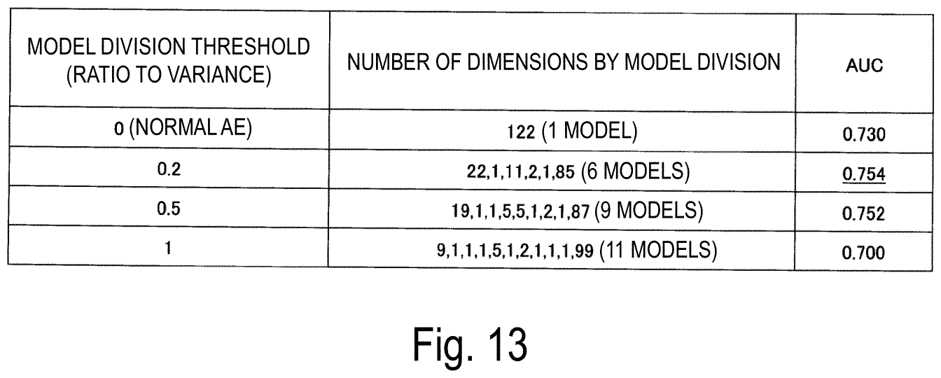

In addition, as a method of acquiring a correlation, a threshold is determined for a link between layers to cut the link and then when outputs are connected, it is considered that there is a correlation. Furthermore, a result is shown in FIG. 13 that a deep learning model for anomaly detection has been divided based on the correlation to perform anomaly detection.

The AUC in FIG. 13 represents the accuracy of anomaly detection, and the higher the AUC, the higher the accuracy of anomaly detection. FIG. 13 indicates that the anomaly detection accuracy varies depending on a threshold for determining a correlation, and that when model division is performed, the accuracy may be improved compared to the case where model division is not performed (threshold=0), and represents the usefulness of this technique because the model division can be performed without lowering the accuracy of the task.

Conclusion of Embodiment

According to the present embodiment, at least the model learning apparatus, the data analysis apparatus, the model learning method, and the program described in each item below are provided.

Item 1

A model learning apparatus, including:

a learning unit configured to train an unsupervised deep learning model using training data;

a calculation unit configured to calculate a correlation between input dimensions in the deep learning model; and

a division model learning unit configured to train an analysis model using the training data for each set of dimensions having a correlation.

Item 2

The model learning apparatus according to item 1, in which the calculation unit calculates a contribution degree for a final output value of each of dimensions of input data in the deep learning model, and calculates a correlation between input dimensions based on the contribution degree.

Item 3

A data analysis apparatus, including a data analysis unit configured to perform data analysis using an analysis model trained by the division model learning unit according to item 1 or 2.

Item 4

A model learning apparatus, including:

a partial learning unit configured to divide dimensions of training data into a plurality of groups and train an unsupervised deep learning model using divided training data for each of the groups; a calculation unit configured to calculate a correlation between input dimensions in the deep learning model for each of the groups;

a feature extraction unit configured to train division models using the training data for each set of dimensions having a correlation, for each of the groups; and

a learning unit configured to train a deep learning model using a feature obtained from each of the division models for each of the groups, and train an analysis model using the training data for each set of dimensions having a correlation between input dimensions in the deep learning model.

Item 5

A data analysis apparatus, including a data analysis unit configured to perform data analysis using an analysis model trained by the learning unit described in item 4.

Item 6

A model learning method performed by a model learning apparatus, the model learning method including:

training an unsupervised deep learning model using training data; calculating a correlation between input dimensions in the deep learning model; and training an analysis model using the training data for each set of dimensions having a correlation.

Item 7

A model learning method performed by a model learning apparatus, the model learning method including:

dividing dimensions of training data into a plurality of groups and training an unsupervised deep learning model using divided training data for each of the groups;

calculating a correlation between input dimensions in the deep learning model for each of the groups;

training division models using the training data for each set of dimensions having a correlation, for each of the groups; and

training a deep learning model using a feature obtained from each of the division models for each of the groups, and training an analysis model using the training data for each set of dimensions having a correlation between input dimensions in the deep learning model.

Item 8

A program for causing a computer to function as each of units in the model learning apparatus described in item 1, 2, or 4.

Although the present embodiment has been described above, the present invention is not limited to such a specific embodiment, and various modifications and changes can be made without departing from the gist of the present invention described in the aspects.

### REFERENCE SIGNS LIST

100 Anomaly detection apparatus

110 Data collection unit

120 Data pre-processing unit

130 Overall training unit

140 Deep learning model division unit

141 Contribution degree calculation unit

142 Correlation calculation unit

143 Division model relearning unit

150 Data analysis unit

200 Anomaly detection apparatus

210 Data collection unit

220 Data pre-processing unit

230 Partial training unit

240 Partial deep learning model division unit

241 Partial contribution degree calculation unit

242 Partial correlation calculation unit

243 Division model feature extraction unit

250 Overall training unit

260 Overall deep learning model division unit

261 Overall contribution degree calculation unit

262 Overall correlation calculation unit

263 Division model relearning unit

270 Data analysis unit

1000 Drive apparatus

1002 Auxiliary storage apparatus

1003 Memory apparatus

1004 CPU

1005 Interface apparatus

1006 Display apparatus

1007 Input apparatus

1. A model learning apparatus, comprising:
a memory; and
one or more processors configured to:
train an unsupervised deep learning model using training data;
calculate a correlation between input dimensions in the deep learning model; and
train an analysis model using the training data for each set of dimensions having a correlation.

2. The model learning apparatus according to claim 1, wherein the model learning apparatus is configured to calculate a contribution degree for a final output value of each of dimensions of input data in the deep learning model, and calculate a correlation between input dimensions based on the contribution degree.

3. The model learning apparatus of claim 1, wherein the one or more processors are configured to perform data analysis using an analysis model trained by the division model learning unit.

4. The model learning apparatus of claim 1, wherein the one or more processors are configured to:
divide dimensions of training data into a plurality of groups and train an unsupervised deep learning model using divided training data for each of the groups;
calculate a correlation between input dimensions in the deep learning model for each of the groups;
train division models using the training data for each set of dimensions having a correlation, for each of the groups;
train a deep learning model using a feature obtained from each of the division models for each of the groups; and
train the analysis model using the training data for each set of dimensions having a correlation between input dimensions in the deep learning model.

5. The model learning apparatus of claim 4, wherein the one or more processors configured to perform data analysis using an analysis model trained by the learning unit described in claim 4.

6. A model learning method performed by a model learning apparatus comprising one or more processors, the model learning method comprising:
training, by the one or more processors, an unsupervised deep learning model using training data;
calculating, by the one or more processors, a correlation between input dimensions in the deep learning model; and
training, by the one or more processors, an analysis model using the training data for each set of dimensions having a correlation.

7. The model learning method of claim 1, further comprising:
dividing dimensions of training data into a plurality of groups;
training an unsupervised deep learning model using divided training data for each of the groups;
calculating a correlation between input dimensions in the deep learning model for each of the groups;
training division models using the training data for each set of dimensions having a correlation, for each of the groups;
training a deep learning model using a feature obtained from each of the division models for each of the groups; and
training the analysis model using the training data for each set of dimensions having a correlation between input dimensions in the deep learning model.

8. A non-transitory recording medium storing instructions of a program for causing a computer to perform operations comprising:
training an unsupervised deep learning model using training data;
calculating a correlation between input dimensions in the deep learning model; and
training an analysis model using the training data for each set of dimensions having a correlation.
